(19) United States
(12) Patent Application Publication
(10) Pub. No.: US 2026/0344741 A1
(43) Pub. Date: Nov. 5, 2026

(54) METHODS OF TREATING BOTANICAL MATERIAL, TREATED BOTANICAL MATERIAL AND USES THEREOF

(71) Applicant: Nicoventures Trading Limited, London (GB)

(72) Inventors: Alina-Mariana CRAINIC, London (GB); Benjamin JENKINS, London (GB); Axel CORTES, London (GB); Pamela LIMA, London (GB)

(21) Appl. No.: 19/488,932

(22) PCT Filed: Jul. 2, 2024
(86) PCT No.: PCT/EP2024/068600

§ 371 Date: Dec. 1, 2025

(30) Foreign Application Priority Data
Jul. 7, 2023 (GB) 2310470.6
Apr. 19, 2024 (GB) 2405583.2

(51) Int. Cl. A24B 15/32; A24B 3/12; A24B 15/167; A24D 1/20

(52) U.S. Cl. CPC A24B 15/32; A24B 3/12; A24B 15/167; A24D 1/20

(57) ABSTRACT

The present invention relates to methods of treating botanical material to incorporate an aerosol-former material. In particular, the methods are suitable for treating leaf material, such as tobacco leaf. The treated material is well suited to being incorporated into aerosol generating material for use in aerosol provision systems and the like.

### FIELD

The present invention relates to methods of treating botanical material to incorporate an aerosol-former material. In particular, the methods are suitable for treating leaf material, such as tobacco leaf. The treated material is well suited to being incorporated into aerosol generating material for use in aerosol provision systems and the like.

### BACKGROUND

It is known to incorporate aerosol-former materials into aerosol generating materials for use in non-combustible aerosol provision systems. This is frequently done by including compositions such as reconstituted materials or dried gel or amorphous solid materials comprising the aerosol-former material.

### SUMMARY

According to a first aspect of the invention, there is provided a method of treating botanical material comprising:
a) a first conditioning step wherein the botanical material is contacted with one or both of steam and water; and
b) a second conditioning step wherein the botanical material is contacted with a mixture of: (i) one or both of steam and water and (ii) an aerosol-former material.

In some embodiments, the method further comprises a soaking step wherein the botanical material produced by step a) is stored in a container for a period of at least about 30 minutes, optionally wherein the botanical material is sealed in the container during the soaking step.

In some embodiments, following step b), the method further comprises a resting step wherein the botanical material produced by step b) is stored in a container for a period of at least 4 hours, and optionally for at least 8 hours.

In some embodiments, the botanical material is sealed in the container during the resting step.

In some embodiments, the moisture content of the botanical material produced by step a) is less than about 20%.

In some embodiments, the temperature during the first conditioning step a) is from about 40 to about 65 °C.

In some embodiments, the moisture content of the botanical produced by step b) is less than about 30%.

In some embodiments, the temperature during the second conditioning step b) is from about 40 to about 65 °C.

In some embodiments, the botanical material to be treated is threshed tobacco leaf or a non-tobacco botanical material, optionally a non-tobacco leaf material.

In some embodiments, the method further comprises removing the outer stem from the leaf before step a).

In some embodiments, the method further comprises drying the botanical material before step a).

In some embodiments, the botanical material has a moisture content of about 5 to about 20 wt % before step a).

In some embodiments, the method further comprises cutting and drying the botanical material following step b).

In some embodiments, the aerosol-former material is one or more selected from the group consisting of: glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the amount of aerosol-former applied to the botanical material is from about 10 to about 25% based on the weight of the botanical material (on a wet weight basis), or from about 15 to about 20% based on the weight of the botanical material (on a wet weight basis).

In some embodiments, an active substance is applied to the botanical material during the second conditioning step.

According to a second aspect of the invention there is provided a botanical material obtained or obtainable by a method according to the first aspect, comprising the aerosol-former material incorporated into the botanical material.

In some embodiments, the botanical material is tobacco leaf or a non-tobacco botanical material, optionally a non-tobacco leaf material.

In some embodiments, the botanical material comprises greater than about 15 wt % (on a dry weight basis) of the aerosol-former material.

According to a third aspect of the invention, there is provided an article for use in an aerosol provision system, the article comprising aerosol-generating material comprising the botanical material according to the second aspect.

In some embodiments, the article comprises the botanical material formed into a rod and circumscribed with a paper wrapper.

### BRIEF DESCRIPTION OF THE FIGURES

Embodiments of the invention will now be described, by way of example only, with reference to the accompanying drawings, in which:

FIG. 1 shows a process flow chart of an exemplary method;

FIG. 2 shows a process flow chart of another exemplary method;

FIG. 3 shows a process flow chart of a further exemplary method;

FIG. 4 shows a process flow chart of another exemplary method;

FIG. 5 is a side-on cross-sectional view of a consumable comprising aerosol generating material according to the invention; and

FIG. 6 is a perspective illustration of a non-combustible aerosol provision device for generating an aerosol from the aerosol-generating material of the consumable shown in FIG. 5.

### DETAILED DESCRIPTION

After harvesting, botanical material can be treated in various ways to prepare the material for use.

Whilst it may be known to add an aerosol-former material to botanical material, this generally results in the aerosol-former material being predominantly or exclusively present on the surface of the botanical material. As the amount of aerosol-former material on the surface of the botanical material increases, the stickier it becomes and, accordingly, the more difficult it may be to process.

The present invention provides methods that result in the botanical material being treated so that the aerosol-former material is absorbed into the cellular structure of the botanical material, with only a minor proportion of the aerosol-former material being present on the surface of the material. As a result, the treated botanical material retains its handleability and the aerosol-former material is also less prone to migration during transport and storage.

In the case of leaf materials, such as tobacco leaf, this also has the advantage that the addition of the aerosol-former may be incorporated into the primary processing of the leaf, rather than having to be applied late in the processing in a separate and additional processing step that will add to the expense and complexity of the processing, as well as potentially additional machinery.

In some embodiments, the methods of the invention permit the addition to a botanical material of at least 15% by weight of an aerosol-former material.

### Botanical Material

As used herein, the term “botanical” or “botanical material” includes any material derived from plants including, but not limited to, extracts, leaves, bark, fibres, stems, roots, seeds, flowers, fruits, pollen, husk, shells or the like. In some embodiments, the botanical material is preferably the leaf of a plant.

In some embodiments, the botanical material is derived from a tobacco plant. For example, the methods are particularly well suited to treating threshed tobacco leaves. In some embodiments, the tobacco is one or more of any tobacco type, including the common tobacco types, such as Virginia, Burley and Oriental.

In other embodiments, the botanical material is derived from plants or materials (botanicals) including: eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v., Mentha spicata crispa, Mentha cardifolia, Mentha longifolia, Mentha suaveolens variegata, Mentha pulegium, Mentha spicata c.v. and Mentha suaveolens

In some embodiments, the botanical is selected from eucalyptus, star anise, cocoa and hemp. In some embodiments, the botanical is selected from rooibos and fennel.

### Aerosol-Former Material

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the aerosol-former material is glycerol, propylene glycol, or a combination of glycerol and propylene glycol. In some embodiments, the glycerol aerosol-former is vegetable glycerol (also referred to as VG).

Depending on the proposed use of the treated botanical material, the materials referred to herein as aerosol-former materials may also be referred to as humectants. The treated botanical material does not have to be used to generate an aerosol.

### Addition of Aerosol-Former Material to Botanical Material

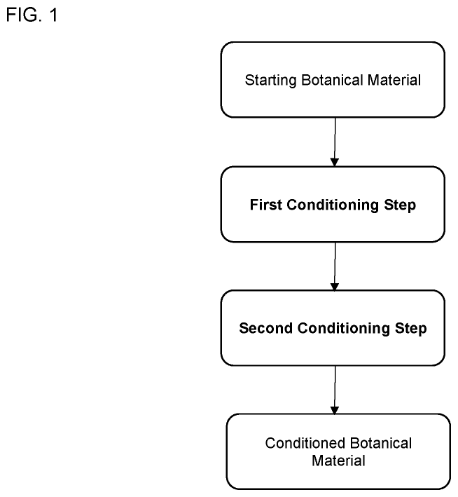

The methods of the present invention involve a two-step process for adding the aerosol-former material to the botanical material. This two-step conditioning process is illustrated in the flow chart of FIG. 1.

The first step is a first conditioning step (also referred to herein as the “pre-conditioning” step) wherein the botanical material is contacted with one or both of steam and water.

In some embodiments, the first conditioning step is carried out in a Direct Conditioning Casing Cylinder (DCCC). Conditioning steam may be provided at both the entrance and the exit of the cylinder.

The first conditioning step involves exposing the botanical material to moisture, either in the form of water, steam, or both. As a result, the moisture content of the botanical material is expected to increase.

When referring to “moisture” it is important to understand that there are widely varying and conflicting definitions and terminology in use. It is common for “moisture” or “moisture content” to be used to refer to water content of a material but in relation to the certain industries, such as the tobacco industry, it is necessary to differentiate between “moisture” as water content and “moisture” as oven volatiles. Water content is defined as the percentage of water contained in the total mass of a solid substance. Volatiles are defined as the percentage of volatile components contained in the total mass of a solid substance. This includes water and all other volatile compounds. Oven dry mass is the mass that remains after the volatile substances have been driven off by heating. It is expressed as a percentage of the total mass. Oven volatiles (OV) are the mass of volatile substances that were driven off.

Moisture content (oven volatiles) may be measured as the reduction in mass when a sample is dried in a forced draft oven at a temperature regulated to 110 °C±1 °C for three hours±0.5 minutes. After drying, the sample is cooled in a desiccator to room temperature for approximately 30 minutes, to allow the sample to cool.

Unless stated otherwise, references to moisture content herein are references to oven volatiles (OV).

In some embodiments, the first conditioning step results in the botanical material having a moisture content of less than about 20% (OV). In some embodiment, the first conditioning step results in botanical material having a moisture content of from about 15 to about 25% (OV), from about 16 to about 22% (OV), from about 16 to about 20% (OV), from about 18 to about 22% (OV), or from about 19 to about 21% (OV), of about 20% (OV) or of about 18% (OV).

In some embodiments, the first conditioning step exposes the botanical material to temperatures above room temperature, and often to temperatures in the range of from about 30 to 100 °C, from about 60 to about 70 °C, or from about 40 to about 65 °C. In some embodiments, the first conditioning step exposes the botanical material to temperature of at least about 30 °C, at least about 35 °C, at least about 40 °C, at least about 45 °C, at least about 50 °C, at least about 55 °C, at least about 60 °C, at least about 65 °C, at least about 70 °C, at least about 75 °C, at least about 80 °C, at least about 85 °C, at least about 90 °C, or at least about 95 °C. In some embodiments, the first conditioning step exposes the botanical material to temperature of no more than about 100 °C, no more than about 95 °C, no more than about 90 °C, no more than about 85 °C, no more than about 80 °C, no more than about 75 °C, no more than about 70 °C, no more than about 65 °C, no more than about 60 °C, no more than about 55 °C, no more than about 50 °C, no more than about 45 °C, no more than about 40 °C, or no more than about 35 °C. In some embodiments, the first conditioning step exposes the botanical material to temperature of about 65 °C.

In some embodiments, this exposure to elevated temperatures during the first conditioning step results in the botanical material having a temperature of from about 30 to about 60 °C.

Where the botanical material is leaf or lamina material, such as tobacco, the first conditioning step results in pliable, open and separated leaf material. The first conditioning step applies steam to gently rehydrate the leaf and to open up the leaf cells.

The first conditioning step is followed by a second conditioning step (also referred to herein as the aerosol-former material addition step) wherein the botanical material is contacted with a mixture of: (i) one or both of steam and water; and (ii) an aerosol-former material.

Without wishing to be bound by any particular theory, it is hypothesised that the first conditioning step involving exposing the botanical material to steam and/or water may open up the cellular structure of the botanical material, preparing it for the second conditioning step during which the water inside the botanical material appears to be replaced by the aerosol-former material, which is applied to the botanical material in combination with steam and/or water. This leads to the botanical material becoming impregnated with the aerosol-former material. This means that the aerosol-former material is located within the botanical material, rather than merely on its surface. For example, the aerosol-former material may be located within the cellular structure of the botanical material.

In some embodiments, the first and second conditioning steps are carried out in the same conditioning cylinder. In other embodiments, the first and second conditioning steps are carried out in different conditioning cylinders. For example, the different conditioning cylinders may be arranged in series.

The second conditioning step involves exposing the botanical material to moisture, either in the form of water, steam, or both, and an aerosol-former material. As a result, the moisture content of the botanical material is expected to increase.

In some embodiments, the second conditioning step results in the botanical material having a moisture content of from about 20% to about 40% (oven volatiles).

In some embodiments, the moisture content of the botanical material immediately following the second conditioning step is at least about 20% (OV), at least about 21%, or at least about 35% (OV). Additionally or alternatively, the moisture content of the botanical material immediately following the second conditioning step is no more than about 40% (OV), no more than about 39%, no more than about 38%, no more than about 37%, no more than about 36%, no more than about 35%, no more than about 34%, no more than about 33%, no more than about 32%, no more than about 31%, no more than about 30%, no more than about 29%, no more than about 28%, no more than about 27%, no more than about 26%, or no more than about 25% (OV). In some embodiments, the moisture content of the botanical material immediately following the second conditioning step is from about 20 to about 30%, from about 20 to about 25%, or from about 22 to about 24% (OV).

In some embodiments, the second conditioning step results in the botanical material having a water content of from about 15 to about 30%, from about 18% to about 24%, or from about 20 to about 22%, or from about 21 to about 23% (as determined by Karl Fisher analysis).

In some embodiments, the water content of the botanical material immediately following the second conditioning step is at least about 15%, at least about 16%, at least about 17%, at least about 18%, at least about 19%, at least about 20%, or at least about 21% (as determined by Karl Fisher analysis). Additionally or alternatively, the water content of the botanical material immediately following the second conditioning step is no more than about 30%, no more than about 29%, no more than about 28%, no more than about 27%, no more than about 26%, no more than about 25%, no more than about 24%, no more than about 23%, no more than about 22%, no more than about 21%, no more than about 20%, no more than about 19%, no more than about 18%, no more than about 17%, no more than about 16%, or no more than about 15% (as determined by Karl Fisher analysis).

In some embodiments, there is a difference in the moisture content (OV) and the water content as determined by Karl Fisher analysis of at least about 2%, at least about 3%, at least about 4%, at least about 5%, at least about 6%, at least about 7%, at least about 8%, at least about 9%, or at least about 10%. Additionally or alternatively, the difference may be up to about 15%, up to about 12%, or up to about 10%.

In some embodiments, the second conditioning step exposes the botanical material to temperatures above room temperature, and often to temperatures in the range of from about 30 to 100 °C or from about 40 to about 65 °C. In some embodiments, the second conditioning step exposes the botanical material to temperature of at least about 30 °C, at least about 35 °C, at least about 40 °C, at least about 45 °C, at least about 50 °C, at least about 55 °C, at least about 60 °C, at least about 65 °C, at least about 70 °C, at least about 75 °C, at least about 80 °C, at least about 85 °C, at least about 90 °C, or at least about 95 °C. In some embodiments, the second conditioning step exposes the botanical material to temperature of no more than about 100 °C, no more than about 95 °C, no more than about 90 °C, no more than about 85 °C, no more than about 80 °C, no more than about 75 °C, no more than about 70 °C, no more than about 65 °C, no more than about 60 °C, no more than about 55 °C, no more than about 50 °C, no more than about 45 °C, no more than about 40 °C, or no more than about 35 °C.

In some embodiments, the temperature of the first conditioning step is substantially the same as the temperature of the second conditioning step.

In some embodiments, the temperature of the first conditioning step is lower than the temperature of the second conditioning step. For example, the temperature difference may be 2, 3, 4, 5, 6, 7, 8, 9 or 10 °C.

In some embodiments, the temperature of the first conditioning step is higher than the temperature of the second conditioning step. For example, the temperature difference may be 2, 3, 4, 5, 6, 7, 8, 9 or 10 °C.

In some embodiments, this exposure to elevated temperatures during the second conditioning step results in the botanical material having a temperature of from about 30 to about 65 °C.

In some embodiments, aerosol-former material is applied to the botanical material in the form of a mixture of the aerosol-former material and water. Water is added to the aerosol-former material to adjust its viscosity and to allow it to be sprayed through the nozzles of the apparatus (e.g., the DCCC). In some embodiments, the ratio of aerosol-former material to water is from about 5:1 to about 1:5.

For application to the botanical material, the mixture of water and aerosol-former material is heated so that it is a mixture of steam and/or water and aerosol-former material. The amount of aerosol-former material that is added or applied to the botanical material refers to the amount of the aerosol-former material in the mixture with water and/or steam that the botanical material is contacted with.

In some embodiments, the amount of aerosol-former material added or applied to the botanical material is from about 10 to about 50 wt % based on the weight of the botanical material that is fed into the first conditioning step.

In some embodiments, the amount of aerosol-former material added or applied to the botanical material is from about 10 to about 30%, from about 15 to about 25% or from about 15 to about 20% aerosol-former material by weight of the botanical material.

In some embodiments, the amount of aerosol-former material applied to the botanical material is at least about 10%, at least about 12%, at least about 15%, at least about 16%, at least about 17%, at least about 18%, at least about 19%, at least about 20%, at least about 21%, at least about 22%, at least about 23%, at least about 24%, or at least about 25% by weight of the botanical material. Additionally or alternatively, the amount of aerosol-former material applied to the botanical material is no more than about 50%, no more than about 45%, no more than about 40%, no more than about 35%, no more than about 32%, no more than about 30%, no more than about 29%, no more than about 28%, no more than about 27%, no more than about 26%, or no more than about 25% by weight of the botanical material.

Where the botanical material is leaf or lamina material, such as tobacco, the second conditioning step results in pliable leaf material with a shiny appearance and high surface moisture. There is little leaf degradation and no dust generation as a result of the second conditioning step.

In some embodiments, the first and second conditioning steps are not separated by a further treatment or processing step. By this it is meant that the botanical material is not cut, dried or expanded, or the like, between the first and second conditioning steps.

In some embodiments, this means that the first conditioning step immediately followed by the second conditioning step.

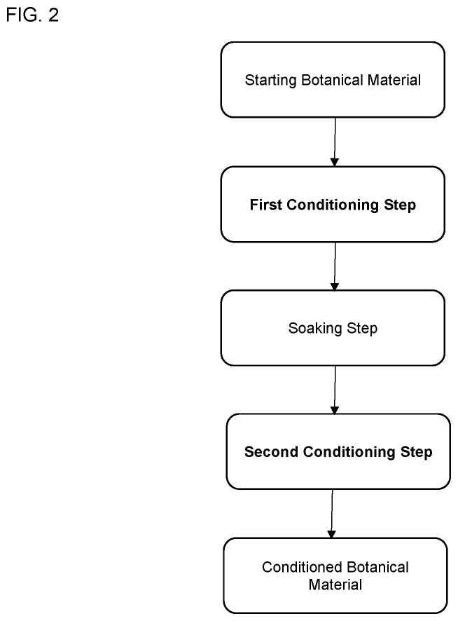

In other embodiments, the botanical material produced by the first conditioning step is stored before undergoing the second conditioning step. This storing step between the conditioning steps is referred to herein as a soaking step. This two-step conditioning process with an intervening soaking step is illustrated in the flow chart of FIG. 2.

In some embodiments, the botanical material produced by the first conditioning step may be stored in a container for a period of at least about 30 minutes and optionally for a period of up to about two hours. In some embodiments, the botanical material is sealed in the container during this soaking step.

In some embodiments, the length of the soaking step is at least about 1 minute, at least about 5, at least about 10, at least about 15, at least about 20, at least about 30, at least about 40, at least about 50 or at least about 60 minutes. Additionally or alternatively, the length of the soaking step is no more than about 120 minutes, no more than about 90 minutes, no more than about 80, no more than about 70, no more than about 60, no more than about 50, no more than about 40, no more than about 30, no more than about 20 or no more than about 10 minutes. In some embodiments, the length of the soaking step is from about 30 to about 120 minutes, from about 30 to about 90 minutes, or from about 30 minutes to about 60 minutes. This refers to the length of time for which the conditioned botanical material is stored following the first conditioning step. In some embodiments, this refers to the length of time for which the conditioned botanical material is stored in a container following the first conditioning step.

In some embodiments, the first conditioning step may be carried out in a DCCC, and the material exiting the DCCC after the first conditioning step may be placed in a container which may, for example, be a box or a wrapper, and held for a period of time before undergoing the second conditioning step.

In some embodiments, the moisture content of the botanical material after the soaking step is below 20% (OV). In some embodiments, botanical material has a moisture content after the soaking step of from about 15 to about 25% (OV), from about 18 to about 22% (OV), or from about 19 to about 21% (OV), or of about 20% (OV).

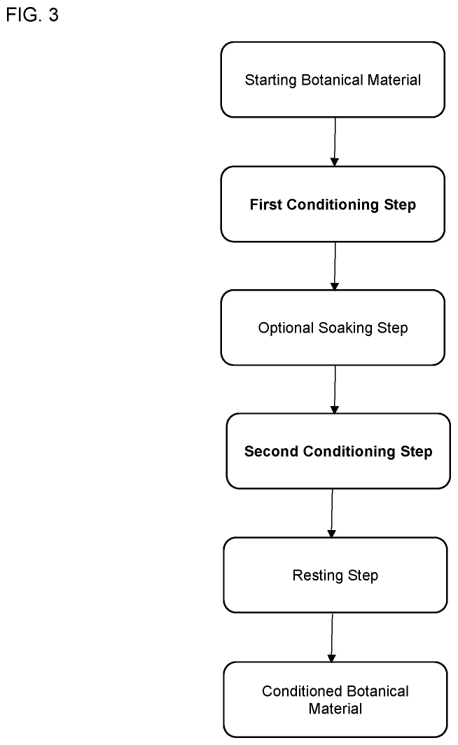

In some embodiments, the botanical material produced by the second conditioning step is stored before undergoing any further treatment or processing. This storing step is referred to herein as a resting step. This two-step conditioning process with a subsequent resting step, and optional intervening soaking step, is illustrated in the flow chart of FIG. 3.

In some embodiments, the botanical material produced by the second conditioning step may be stored in a container for a period of at least about 30 minutes. In some embodiments, the botanical material is sealed in the container during this resting step.

In some embodiments, the length of the resting step is at least about 30 minutes, at least about 1 hour, at least about 2, at least about 3, at least about 4, at least about 5, at least about 6, at least about 7, at least about 8, at least about 9, at least about 10, at least about 11, at least about 12 or at least about 15 hours. Additionally or alternatively, the length of the resting step is no more than about 24 hours, no more than about 22 hours, no more than about 20 hours, no more than about 19 hours, no more than about 18 hours, no more than about 17 hours, no more than about 16 hours, no more than about 15 hours, no more than about 14, no more than about 13, no more than about 12, no more than about 11, no more than about 10, no more than about 9, no more than about 8, no more than about 7 or no more than about 6 hours.

In some embodiments, the length of the resting step is from about 4 to about 18 hours, from about 6 hours to about 18 hours or from about 8 to about 15 hours. In other embodiments, the length of the resting step is from about 0.5 to about 3 hours.

In some embodiments, an active substance is applied to the botanical material with the aerosol-former material during the second conditioning step. For example, the active substance may be added to the mixture of water and aerosol-former material. Alternatively, the active substance may be introduced into the second conditioning step separately from the steam and aerosol-former material.

The active substance as used herein may be a physiologically active material, which is a material intended to achieve or enhance a physiological response. The active substance may, for example, be selected from nutraceuticals, nootropics, psychoactives. The active substance may be naturally occurring or synthetically obtained. The active substance may comprise, for example, nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. The active substance added to the botanical material may be an active substance that is already present in the botanical material undergoing the treatment, or it may be a different active substance.

In some embodiments, the active substance comprises nicotine. In some embodiments, the active substance comprises caffeine, melatonin or vitamin B12. In some embodiments, the active substance may comprise one or more constituents, derivatives or extracts of cannabis, such as one or more cannabinoids or terpenes.

In some embodiments, the additional active substance is applied during the second conditioning step by being sprayed onto the botanical material. In such embodiments, the additional active preferably has low volatility, to minimise the amount of the active that may be lost during any drying step that may follow the second conditioning step.

In some embodiments, one or more additional active may be added via casing after the second conditioning step. For instance, in a mixture comprising the active mixed with glycerol, water and other optional flavour ingredients may be sprayed onto the conditioned botanical material.

### Additional Processing Steps Before Conditioning

In some embodiments, the botanical material may undergo one or more treatment or processing steps before the first conditioning step. This earlier processing or treatment may or may not form part of the claimed method.

In some embodiments, the botanical material that undergoes the first conditioning step has been dried.

In some embodiments, the botanical material has a moisture content of about 5 to about 20 wt %, as measured by gas chromatography-thermal conductivity detector (GC-TCD) or Karl Fischer measurement before undergoing the first conditioning step. In some embodiments, the moisture content of the botanical material immediately prior to the first conditioning step is at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt % or at least about 15 wt %. Additionally or alternatively, the moisture content of the botanical material immediately prior to the first conditioning step is no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, or no more than about 15 wt %.

Thus, in some embodiments, the botanical material that undergoes the first conditioning step is a leaf material that has been threshed. Additionally or alternatively, the outer stem has been removed from the leaf.

In some embodiments, the botanical material is tobacco leaf that has completed so-called “green-leaf threshing” (GLT) processing, during which the harvested tobacco leaf has been blended, the leaf butts cut (for example, 11 cm cut from the leaf butt), the leaf dried in an apron dryer, then pressed and optionally boxed for transport to a suitable location for so-called primary processing (PMD), which will incorporate the two conditioning steps of the present invention.

In some embodiments, a non-tobacco botanical leaf material may undergo one or more of the GLT processing steps.

Additional Processing Steps after Conditioning

In some embodiments, the botanical material may undergo one or more treatment or processing steps after the second conditioning step. This subsequent processing or treatment may or may not form part of the claimed method.

These additional processing steps may be particularly relevant where the botanical material is leaf or lamina material, such as tobacco leaf or lamina.

For example, one or more of the following treatment or processing steps may be included in the claimed methods or may be applied to the product of the claimed methods.

In some embodiments, the conditioned botanical material may be cut. For example, the material may be cut by 22 or 32 CPI (cuts per inch), which is a conventional cutting step for threshed tobacco leaf in the preparation of cut rag.

In some embodiments, the conditioned, and optionally cut, botanical material is dried in a first drying step. A suitable dryer for this drying step may be a rotary dryer. In some embodiments, the rotary dryer may operate with an air temperature of up to about 100 °C to provide a dried botanical material with a moisture content of from about 10 to about 20% (OV), or a moisture content of from about 15% to about 18% (OV).

In some embodiments, the rotary dryer operates with an air temperature of from about 100 to about 150 °C, from about 120 to about 150 °C, or of about 140 °C. The mass flow may be from about 150 to about 300 kg/hr, from about 150 to about 250 kg/hr, from about 175 to about 225 kg/hr, or may be of about 200 kg/hr or of about 250 kg/hr. The steam pressure within the rotary dryer may be from about 5 to about 2.5, from about 4.5 to about 3, or may be about 3.6 Bar. In some embodiment, the steam pressure within the rotary dryer may be from about 1 to about 4 or from about 2 to about 2.5 Bar, or may be about 2.2 Bar.

In some embodiments, the drying may be gentler than the conventional drying step carried out following cutting. This may be due to the fact that the moisture content of the cut tobacco following the conditioning steps according to the present invention may be lower than that of conventionally conditioned and cut tobacco, with moisture content of from about 20 to about 25% (OV), as opposed to the conventional moisture content of about 30% (OV). This may enable the retention of desirable volatile components within the conditioned and cut tobacco.

In some embodiments, the drying may result in the dried botanical material having a water content of from about 10 to about 15%, or a water content of about 13% (as determined by Karl Fischer analysis).

In some embodiments, the botanical material is sufficiently dried by the rotary dryer and does not undergo one or more further drying step(s).

In other embodiments, the conditioned botanical material may be dried in a further drying step. For example, the botanical material may be dried in an air dryer, such as an apron dryer, in which a bed of the material is dried in zones which each have a controlled temperature to provide optimum processing conditions. In some embodiments, the temperature in one or more of the zones in the dryer may be from about 45 to about 60 °C. In some embodiments, the resultant dried botanical material has a moisture content of from about 10% to about 15% (OV), or from about 10 to about 13% (OV).

The water content of the botanical material following two drying steps may be determined by Karl Fisher analysis, and may be from about 5 to about 9%, or from about 6 to about 8%.

In some embodiments, the botanical material is further treated by adding components such as casings and/or top flavours. These are generally applied to the surface of the conditioned botanical material, whilst the material is agitated.

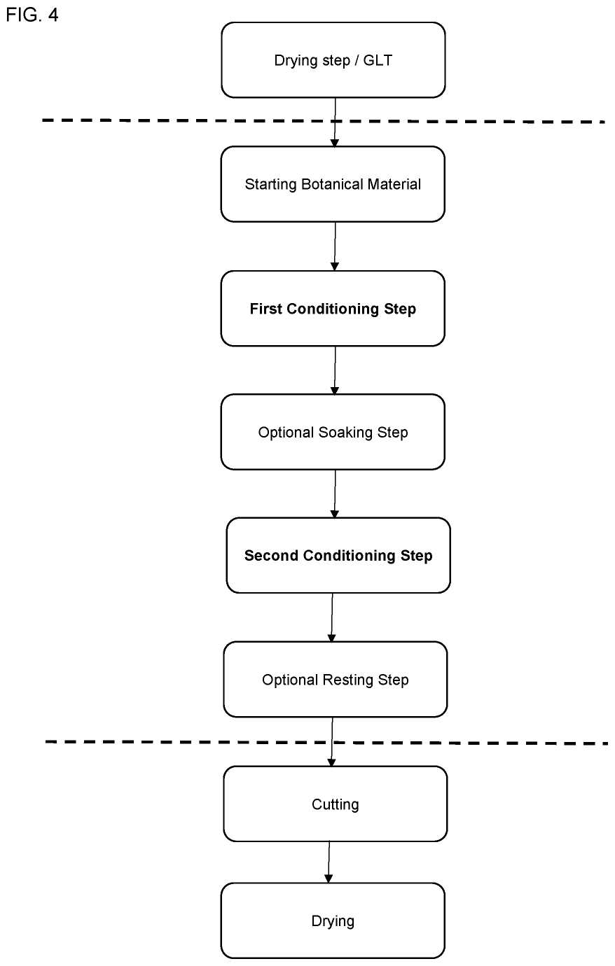

The flow chart of FIG. 4 shows the two-step conditioning process preceded by a pre-drying step or GLT (above the upper dotted line) and subsequent processing steps including cutting and drying (below the lower dotted line).

In further optional steps, the conditioned, cut and dried botanical material may be blended with other materials, such as other botanical material(s) or differently processed material. For example, where the botanical material is tobacco lamina, this material may be blended with other tobacco materials, such as expanded tobacco (DIET) or reconstituted tobacco, or blended with other botanical materials or other sheet materials such as gel sheets.

### Treated Botanical Material

The methods of the present invention produce conditioned botanical material comprising an aerosol-former and having a variety of beneficial properties. Properties of the treated material (after second conditioning step and any optional resting step thereafter) and associated advantages may include one or more of the following.

The aerosol-former material content of the treated botanical material is greater than about 10 wt % or greater than about 15 wt % (on a dry weight basis) of the aerosol-former material, determined by gas chromatography. This high aerosol-former material content means that the botanical material can produce better aerosol and/or vapour when heated and may even obviate the need for a further, separate source of aerosol-former material in the aerosol-generating material and/or the aerosol provision system. Such separate sources of aerosol-former material have, in the past, included reconstituted materials or dried gel materials. These involve significant additional cost and will often have negative environmental implications associated with the ingredients included, the large amount of water required for manufacture, and/or the energy costs associated with manufacture.

In some embodiments, the treated botanical material comprises from about 10 to about 30 wt %, from about 15 to about 30 wt %, or from about 15 to about 20 wt % aerosol-former material on a dry weight basis. In some embodiments, the treated botanical material comprises at least about 10 wt %, at least about 11 wt %, at least about 12 wt %, at least about 12.5 wt %, at least about 13 wt %, at least about 13.5 wt %, at least about 14 wt %, at least about 14.5 wt %, at least about 15 wt %, at least about 15.5 wt %, at least about 16 wt %, at least about 16.5 wt %, at least about 17 wt %, at least about 17.5 wt %, at least about 18 wt %, at least about 18.5 wt %, or at least about 19 wt % aerosol-former material. Alternatively or additionally, the treated botanical material comprises up to about 30 wt %, up to about 29 wt %, or up to about 28 wt %, up to about 27 wt %, up to about 26 wt %, up to about 25 wt %, up to about 24 wt %, up to about 23 wt %, up to about 22 wt %, up to about 21 wt %, or up to about 20 wt % aerosol-former material.

In some embodiments, the treated botanical material comprises from about 10 to about 20 wt % water, or from about 14 to about 16 wt % water. In some embodiments, the treated botanical material comprises at least about 10 wt %, at least about 11 wt %, at least about 12 wt %, at least about 13 wt %, at least about 14 wt %, or at least about 15 wt % water. Alternatively or additionally, the treated botanical material comprises up to about 30 wt %, up to about 25 wt %, up to about 20 wt %, up to about 19 wt %, up to about 18 wt %, up to about 17 wt %, up to about 16 wt %, or up to about 15 wt % water.

In some embodiments, the two-step conditioning of the botanical material increases the fill value of the material beyond the fill value achieved with the conventional conditioning.

In some embodiments, the treated botanical material has a fill value of from about 3 to about 7 cc/g, from about 3.5 to about 6 cc/g, or from about 4 to about 5 cc/g.

In some embodiments, the treated botanical material has a fill value of at least about 3.5 cc/g, at least about 4 cc/g, at least about 4.1 cc/g, at least about 4.2 cc/g, at least about 4.3 cc/g, at least about 4.4 cc/g, at least about 4.5 cc/g, at least about 4.6 cc/g, at least about 4.7 cc/g, at least about 4.8 cc/g, or at least about 4.9 cc/g. Alternatively or additionally, the treated botanical material has a fill value of up to about 7 cc/g, up to about 6.5 cc/g, up to about 6 cc/g, up to about 5.5 cc/g, up to about 5 cc/g, up to about 4.9 cc/g, up to about 4.8 cc/g, up to about 4.7 cc/g, up to about 4.6 cc/g, up to about 4.5 cc/g, up to about 4.4 cc/g, up to about 4.3 cc/g, up to about 4.2 cc/g, up to about 4.1 cc/g, up to about 4 cc/g, up to about 3.9 cc/g, up to about 3.8 cc/g, up to about 3.7 cc/g, up to about 3.6 cc/g, or up to about 3.5 cc/g. The fill value is measured using a densometer, weighing a known volume of cut rag to determine the volume by mass.

An increased fill value has the benefit that the treated botanical material is lighter and produces lighter products, such as consumable. This can lower transport costs and other costs associated with the products. In the case of tobacco, the increased fill value may reduce the excise payable on the tobacco material and/or products including it.

In some embodiments, the two-step conditioning of the botanical material increases the aerosol-former material content whilst avoiding making the botanical material sticky or tacky. This has the benefit of ensuring that the botanical material has good handleability and processability. For example, the botanical material does not contaminate the machinery used to process the botanical material following the two-step conditioning, such as the cutter, and machinery used to form products containing the botanical material. This allows the machinery to rapidly process the material without problems.

The stickiness of the treated botanical material can be assessed by measuring the static friction of the material. It has been found that the treatment of the botanical material with a second conditioning step applying the aerosol-former material does not result in a significant increase in the static friction compared to material that has been conditioned without the addition of the aerosol-former material. This indicates that the treatment according to the present invention does not result in a significant proportion of the aerosol-former being deposited on the surface of the botanical material, which would make the treated material sticky or tacky.

In some embodiments, the treated botanical material has a static friction of from about 0.2 to about 0.8, from about 0.2 to about 0.6, from about 0.2 to about 0.5, from about 0.2 to about 0.4 or from about 0.2 to about 0.3. In some embodiments, this treated botanical material is cut rag formed from tobacco leaf that has been processed as disclosed herein, with a second conditioning step applying an aerosol-former material such as glycerol in an amount of 20 to 25%.

In some embodiments, the two-step conditioning of the botanical material increases the flexibility and/or pliability of the conditioned botanical material. This has the benefit of resulting in improved processing. For example, the more pliable material can be accurately and consistently cut, with less breakage and dust formation being observed and thus less waste.

In some embodiments, the two-step conditioning of the botanical material provides a particularly attractive and consistent appearance of the material which may be visible in the final product.

### Aerosol-Generating Material

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e., non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 9 0 wt %, 95 wt % or 100 wt % of amorphous solid.

The aerosol-generating material may comprise one or more active substances and/or flavours, one or more aerosol-former materials, and optionally one or more other functional material.

The aerosol-generating material may comprise or substantially consist of the treated botanical material disclosed herein. In some embodiments, the aerosol-generating material is formed from botanical material that has undergone the first and second conditioning steps.

### Consumable

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some embodiments, the consumable comprising the treated botanical material and/or aerosol generating material as disclosed herein can include a simple paper wrapper surrounding the aerosol generating material.

When botanical material such as tobacco leaf has been treated with high levels of aerosol-former material so that this is present on the surface of the botanical material, the aerosol-former material is prone to migration and can leech into a paper wrapper it is in contact with. This can produce unsightly staining of the paper wrapper. Attempts to address this negative effect of the aerosol-former material include double wrapping of the aerosol generating material and/or the inclusion of a wrapper that will not adsorb the aerosol-former, such as a metal foil. This is undesirable as it is expensive and makes the consumables less sustainable from an environmental perspective.

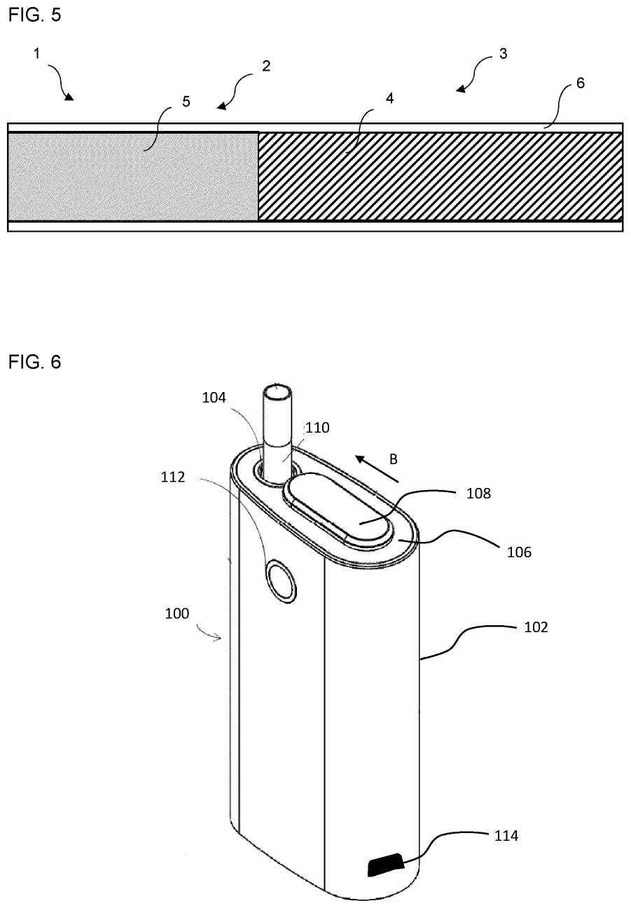

FIG. 5 is a side-on cross-sectional view of a consumable or article 1 for use in an aerosol delivery system. The article 1 comprises a mouthpiece segment 2, and an aerosol generating segment 3.

The aerosol generating segment 3 is in the form of a cylindrical rod and comprises an aerosol-generating material 4 comprising a treated botanical material as disclosed herein. For example, the treated botanical material may be tobacco leaf or lamina treated with glycerol, as discussed herein.

Although described above in rod form, the aerosol-generating segment 3 can be provided in other forms, for instance a plug, pouch, or packet of material within an article.

The mouthpiece segment 2, in the illustrated embodiment, includes a body of material 5 such as a fibrous or filamentary tow.

The rod-shaped consumable 1 further comprises a wrapper 6 circumscribing the mouthpiece segment 2 and aerosol generating segment 3, such as a paper wrapper.

### Susceptor

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

### Aerosol Generator

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

### Delivery System

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material); and
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo and a cigar.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

FIG. 6 shows an example of a non-combustible aerosol provision device 100 for generating aerosol from an aerosol-generating medium such as the aerosol-generating material of a consumable 110, as described herein. In broad outline, the device 100 may be used to heat a replaceable article 110 comprising the aerosol-generating medium, for instance an article 1 as illustrated in FIG. 1 or as described elsewhere herein, to generate an aerosol or other inhalable medium which is inhaled by a user of the device 100. The device 100 and replaceable article 110 together form a system.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 6, the lid 108 is shown in an open configuration, however the lid 108 may move into a closed configuration. For example, a user may cause the lid 108 to slide in the direction of arrow “B”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

### Example 1

The methods disclosed herein may be used to produce tobacco leaf material with a glycerol content of at least 15 wt %. The following is an illustrative example and is not to be construed as reflecting the full scope of the disclosure and claims.

The process used starting tobacco material that was the output of a conventional green leaf threshing (GLT) processing of a blend of tobacco types, including flue-cured Virginia tobacco, in leaf form.

The GLT processing included the following steps:
(1) Blending
(2) Butt cutting to remove 11 cm of the stem
(3) Drying in an apron dryer to a target moisture content of about 15%
(4) Storage and transport (to primary processing plant)

Next, the tobacco material was fed into a DCCC for the first conditioning step of the invention. Specifically, a batch of 100 kg was fed into the DCCC at a rate of 100 kg/h and exposed to steam. The tobacco exiting the DCCC after this first conditioning step had a moisture content of about 20% and a temperature of about 50 °C. The open leaves were then transferred to a box for storage for approximately 30 minutes or about 2 hours, the so-called soaking step.

Next, the tobacco material was fed into the DCCC for the second conditioning step of the invention. Specifically, the batch of 100 kg was fed into the DCCC at a rate of 100 kg/h and exposed to steam and a mixture of 20 to 30 wt % glycerol and water. The glycerol is mixed with water to reduce the viscosity of the glycerol and to allow the mixture to be sprayed using a pump. The steam is generated in the DCCC while the mixture of glycerol and water is sprayed on the leaf.

The tobacco exiting the DCCC after this second conditioning step had a moisture content of about 30% and a temperature of about 55 °C. The tobacco was then transferred to a C48 box for storage for approximately 15 hours, the so-called resting step.

Following the resting step, the conditioned tobacco was removed from the box and cut to a size of 22 or 32 CPI. Thereafter, the cut tobacco was agitated to open the strings to ensure that the material was uniformly dried in the rotary dryer into which it was subsequently fed. In the rotary dryer, the air temperature was about 100 °C and the tobacco was exposed to steam. This rotary dryer processing reduced the moisture content of the cut conditioned tobacco to about 13%.

In an optional additional drying step, the material was further dried to a target moisture content of about 10% in an apron dryer with a lower air temperature (approximately 55 °C).

Analysis of samples of the conditioned tobacco revealed the following properties:

| Property | Sample 1 | Sample 2 |
|---|---|---|
| Mean Oven Volatiles ex DCCC | 32.77% | 31.97% |
| Mean Oven Volatiles ex Rotary Dryer | 16.34% | 16.49% |
| Mean Oven Volatiles ex Apron Dryer | 11.01% | 11.6% |
| Mean water content (KF) ex Apron Dryer | 6.51% | 6.87% |
| Mean Nicotine content (GC) ex Apron | 2.59% | 2.49% |
| Dryer (DWB) | | |
| Mean Glycerol content (GC) ex Apron | 14.90% | 18.74% |
| Dryer (DWB) | | |
| Mean Fill Value ex Apron Dryer | 4.94 cc/g | 4.23 cc/g |
| Mean Fill Value ex Apron Dryer @13.5% | 4.18 cc/g | 3.69 cc/g |
| moisture | | |

After the optional second drying step, casings and top flavours were added and the material was ready for incorporation into a consumable.

The conditioned tobacco in the form of cut rag was readily used to form rods of aerosol-generating material in a consumable, using conventional machinery as might be used to manufacture factory made cigarettes.

### Example 2

In this trial, the inventors looked at the impact of different soaking times and different glycerol content applied on the final glycerol level. The samples were prepared as follows:

Sample CR23/061: 20% glycerol applied and 1 hour of soaking, followed by an overnight resting step for approximately 15 hours.

Sample CR23/062: 20% glycerol applied and 2 hours of soaking, followed by an overnight resting step for approximately 15 hours.

Sample CR23/063: 25% glycerol applied and 1 hour of soaking, followed by overnight resting step for approximately 15 hours.

Sample CR23/064: 25% glycerol applied and 2 hours of soaking, followed by overnight resting step for approximately 15 hours.

Analysis of at least three replicates of each of the samples following drying in a rotary dryer revealed the following properties:

| | CR23/ | CR23/ | CR23/ | CR23/ |
|---|---|---|---|---|
| Property | 061 | 062 | 063 | 064 |
| Mean Fill Value (cc/g) | 3.764 | 3.800 | 3.608 | 3.665 |
| Mean Fill Value @13.5% | 4.168 | 4.407 | 3.881 | 3.884 |
| moisture (cc/g) | | | | |
| Mean Moisture Content (%) | 14.98 | 15.72 | 14.57 | 14.36 |
| Mean Oven Volatiles (%) | 14.85 | 15.14 | 14.75 | 14.50 |
| Mean Water Content (KF) (%) | 11.09 | 10.78 | 10.70 | 10.41 |
| Mean Glycerol Content | 15.670 | 16.223 | 19.427 | 16.807 |
| (GC) (DWB) (%) | | | | |
| Mean Nicotine Content | 2.617 | 2.587 | 2.490 | 2.603 |
| (GC) (DWB) (%) | | | | |

It appeared that the fill value was slightly lower when the samples were tested after only being dried in the rotary dryer versus also being dried in an apron dryer. The other measurements showed high glycerol content and good properties for use as an aerosolisable material in a non-combustible aerosol provision system.

### Example 3

In a further trial, tobacco material was treated as follows:
First Conditioning Step a) with exit OV target of 18%:
   Infeed mass flow ~250 kg/hour; water flow 4-5 kg/hour
Soaking Step:
   2-hour soak period
Second Conditioning Step b) with exit OV target of 22%:
   Glycerol applied at 16%
Resting Step:
   2-hour resting period
Cutting (no processing issues although some deposits of glycerol were noted)
Drying with exit water content target of 10.5%:
   Dryer set to 2.2 bar (+0.2 additional bar to the usual calculations); ~141 °C; mass flow 250 kg/hour

The final blend produced was analysed and had the following properties:

| Property | |
|---|---|
| Mean Fill Value (cc/g) | 4.47 |
| Mean Fill Value @13.5% moisture (cc/g) | 4.72 |
| Mean Moisture Content (%) | 14.26 |
| Mean Oven Volatiles (%) | 14.27 |
| Mean Water Content (KF) (%) | 10.31 |
| Mean Glycerol Content (GC) (DWB) (%) | 11.13 |
| Mean Nicotine Content (GC) (DWB) (%) | 2.39 |

The resultant dried cut rag tobacco felt softer that conventionally processes cut rag tobacco and long strand lengths were present, suggesting that the tobacco was less brittle and more pliable.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A method of treating botanical material comprising:
a) a first conditioning step wherein the botanical material is contacted with one or both of steam and water; and
b) a second conditioning step wherein the botanical material is contacted with a mixture of: (i) one or both of steam and water and (ii) an aerosol-former material.

2. A method as claimed in claim 1, further comprising a soaking step wherein the botanical material produced by step a) is stored in a container for a period of at least about 30 minutes, optionally wherein the botanical material is sealed in the container during the soaking step.

3. A method as claimed in claim 1 or claim 2, wherein, following step b), the method further comprises:
a resting step wherein the botanical material produced by step b) is stored in a container for a period of at least 4 hours, and optionally for at least 8 hours.

4. A method as claimed in claim 3, wherein the botanical material is sealed in the container during the resting step.

5. A method as claimed in any one of claims 1 to 4, wherein the moisture content of the botanical material produced by step a) is less than about 20%.

6. A method as claimed in any one of claims 1 to 5, wherein the temperature during the first conditioning step a) is from about 40 to about 65 °C.

7. A method as claimed in any one of claims 1 to 6, wherein the moisture content of the botanical produced by step b) is less than about 30%.

8. A method as claimed in any one of claims 1 to 7, wherein the temperature during the second conditioning step b) is from about 40 to about 65 °C.

9. A method as claimed in any one of claims 1 to 8, wherein the botanical material to be treated is threshed tobacco leaf or a non-tobacco botanical material, optionally a non-tobacco leaf material.

10. A method as claimed in claim 9, wherein the method further comprises removing the outer stem from the leaf before step a).

11. A method as claimed in any one of claims 1 to 8, wherein the method further comprises drying the botanical material before step a).

12. A method as claimed in any one of claims 1 to 11, wherein the botanical material has a moisture content of about 5 to about 20 wt % before step a).

13. A method as claimed in any one of claims 1 to 12, wherein the method further comprises cutting and drying the botanical material following step b).

14. A method as claimed in any one of claims 1 to 13, wherein the aerosol-former material is one or more selected from the group consisting of: glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

15. A method as claimed in any one of claims 1 to 14, wherein the amount of aerosol-former applied to the botanical material is from about 10 to about 25% based on the weight of the botanical material (on a wet weight basis), or from about 15 to about 20% based on the weight of the botanical material (on a wet weight basis).

16. A method as claimed in any one of claims 1 to 15, wherein an active substance is applied to the botanical material during the second conditioning step.

17. A botanical material obtained or obtainable by a method as claimed in any one of claims 1 to 16, comprising the aerosol-former material incorporated into the botanical material.

18. A botanical material as claimed in claim 17, wherein the botanical material is tobacco leaf or a non-tobacco botanical material, optionally a non-tobacco leaf material.

19. A botanical material as claimed in claim 17 or claim 18, comprising greater than about 15 wt % (on a dry weight basis) of the aerosol-former material.

20. An article for use in an aerosol provision system, the article comprising aerosol-generating material comprising the botanical material as claimed in any one of claims 17 to 19.

21. An article as claimed in claim 20, comprising the botanical material formed into a rod and circumscribed with a paper wrapper.
